(19) United States
(12) Patent Application Publication
(10) Pub. No.: US 2013/0001331 A1
(43) Pub. Date: Jan. 3, 2013

(54) FULL CONE SPRAY NOZZLE FOR A LOW PRESSURE FIRE PROTECTION SYSTEM

(75) Inventor: Carsten Palle, Svendborg (DK)

(73) Assignee: VID Fire-Kill ApS, Svendborg (DK)

(21) Appl. No.: 13/582,176

(22) PCT Filed: Mar. 4, 2011
(86) PCT No.: PCT/DK2011/050069

§ 371 Date: Sep. 14, 2012

(30) Foreign Application Priority Data
Mar. 4, 2010 (DK) PA 2010 70086

(51) Int. Cl. A62C 31/02

(52) U.S. Cl. 239/589

(57) ABSTRACT

A low pressure water mist nozzle for active fire protection from water supplied with supply water pressures of 0.5 bar to 20 bars, characterized by having a separation wall (3) with multiple openings (4) of sizes 01 mm to 02, 5 mm in angles of 10° to 50° to the wall surfaces, which are followed by a cavity (8) having a centrally located outlet opening (6) in its end wall, which are located opposite the separation wall (3) containing multiple openings (4).

The invention relates to a low pressure water mist nozzle for active fire protection, operating with water pressures of 0.5 bar to 20 bars on the nozzle inlet port, to distribute a full cone spray of water where more than 70% of the water volume is sprayed in droplets, having droplet diameter less than 1 mm.

Full cone spray water mist nozzles for fire protection are known from high pressure water mist nozzles, which operate with water inlet pressures of 20 bars to 200 bars. The high water pressures causes inconveniencies to the pipe systems, which should withstand high water pressures, be able to withstand corrosion and cavitations from water at high pressures and flow rates. This sets high demands to the system water pipes, and water pumps, which has to be made in corrosion resistant materials, making the high pressure water mist systems complicated and price expensive. Another problem with high pressure water mist systems is that nozzles have small orifices, to limit the water flow sizes from the nozzles. The small orifice bores make high pressure water mist nozzles sensitive to clogging from impurities in water and pipe systems.

The above mentioned problem has been solved in low pressure water mist nozzles having water deflectors surfaces, on which the kinetic water energy transform water with small supply pressures into sprays consisting of small water droplets. A problem with water mist nozzles having deflectors is that the nozzles become sensitive to physical impacts, which may displace the positions of deflector surfaces to the orifices supplying water on to the deflector surfaces. Another problem with deflector water mist nozzles is to be able to transform water sprays into a fine droplet size distribution pattern, being ideal for fire protection.

The purpose of the present invention is to supply a practical solution to the above mentioned problems.

The invention differs from known low pressure water mist nozzles for active fire protection by, internally in the nozzle housing, to house a swivel plate having multiple Ø1 mm to Ø2.5 mm openings in angles of 10°-50° to the swivel plate surfaces, and a downstream swivel chamber having a central opening in the wall opposite the swivel plate.

A variant of the invention is characterized by the outlet opening of the swivel chamber having a size of ø1.5 mm to ø3 mm. This allows adjustments of water flow and water distribution angle from the nozzle.

Another variant of the invention is characterized by having a centrally located opening in the swivel plate. The opening makes the nozzle have full cone water distribution.

A third variant of the invention is characterized in that the outlet opening of the swivel chamber has an increasing cross section diameter.

Hereby the spray angle of the low pressure water mist nozzle is increased.

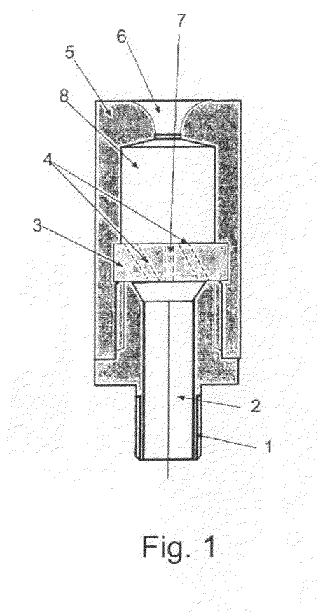

FIG. 1 shows an example of the invention. (1) is a threaded connection to the agent supply pipe system. (2) is the agent supply inlet port. (3) is an agent swivel plate. (4) is angled openings in the agent swivel plate. (7) is a centrally located opening in the swivel plate. (5) is the nozzle housing. (8) is the agent swivel chamber and (6) is the exit opening of the swivel chamber, having an increasing cross-sectional area.

The invention performs with that the agent (water) having low supply pressures at 0.5 bar to 20 bars flows through the inlet port (2) into the nozzle housing. Here the agent flows through the angled openings (4) in the swivel plate (3) which transforms the agent jets, which rotates the agent staying in the swivel chamber (8). The friction between agent jets from the angle openings (4), and agent jet from the centre opening (7), makes the agent jet from the central opening (7) rotate. The agent flows from the swivel chamber (8) through the central exit opening (6) having an increasing cross-sectional area allowing the agent to rotate through the opening. This results in a large distribution area of the agent water mist spray.

1. A low pressure water mist nozzle for active fire protection from water supplied with supply water pressures of 0.5 bar to 20 bars, which are characterized by having a separation wall with multiple openings of sizes 01 mm to 02.5 mm in angles of 100 to sao to the wall surfaces, which are followed by a cavity having a centrally located outlet opening in its end wall, which are located opposite the separation wall containing multiple openings.

2. A low pressure water mist nozzle of claim 1, characterized by the size of the centrally located opening having a diameter of 01.5 mm to 03 mm.

3. A low pressure water mist nozzle of claim 1, characterized by having a centrally located opening in separation wall.

4. A low pressure water mist nozzle of claim 1, characterized by the outlet opening having an increasing cross-sectional area.
